(19) United States
(12) Patent Application Publication
(10) Pub. No.: US 2010/0020156 A1
(43) Pub. Date: Jan. 28, 2010

(54) METHOD AND DEVICE FOR SIMULTANEOUS MULTIPOINT DISTRIBUTING OF VIDEO, VOICE AND DATA

(76) Inventors: Tamir Berler, Tel Aviv (IL); Avraham Sless, Even Yehuda (IL)

Correspondence Address: YORAM TSIVION, P.O. BOX 1307, PARDES HANNA, 37111, IL

(21) Appl. No.: 12/573,127

(22) Filed: Oct. 4, 2009

Related U.S. Application Data
(63) Continuation-in-part of application No. 10/468,770, filed on Jan. 6, 2004, now Pat. No. 7,626,949.

(51) Int. Cl. H04N 7/14; H04L 12/16

(52) U.S. Cl. 348/14.09; 370/260; 348/E07.077

(57) ABSTRACT

The present invention provides a system and method for distributing video, voice and data simultaneously to multiple end-points over packet switching networks, compliant with H.323 or SIP standard. A customer connected to the H.323 or SIP compliant LAN receives a copy datagram stream produced by one-to-many proxy server (OTMPS). Control is granted to customer, subject to permission by a control module, also connected to the LAN.

### CROSS-REFERENCE TO RELATED APPLICATIONS

This patent application is a continuation-in-part of U.S. patent application Ser. No. 10/468,770; PCT/IL02/00118 filed 17 Feb. 2002, entitled “METHOD AND DEVICE FOR SIMULTANEOUS MULTIPOINT DISTRIBUTING OF VIDEO, VOICE AND DATA”. The aforementioned application is incorporated herein in its entirety by this reference.

### FIELD OF THE INVENTION

The present invention relates generally to video transmission over internet protocol compliant networks. More specifically the invention deals with simultaneous distribution to multiple end-points of video on such networks.

### BACKGROUND OF THE INVENTION

Videoconferencing is defined as a technique for intercommunicating two or more audiovisual end-points interactively, such that video is facilitated between the parties involved. Full two-way audio and video is costly and requires analog video channels or high capacity digital channel. Present day videoconferencing is implemented by using either IP networks or ISDN. A more common configuration is that of Interactive TV, which includes full service out, audio only in. The components of a videoconferencing system end-point are a camera, microphone, video display. Generally, to transmit the required data effectively, a large bandwidth is necessary. It is however possible to use a codec (Compression/Decompression) device, to compress the audio signal and thus get more data for the same available bandwidth. If more then two end-points are involved, a component called MCU (Multipoint Conferencing Unit) must be employed. Such a component is implemented either in software or in hardware, and it allows more than one user to be on the screen at one time. Some such commercial devices can show a multiplicity of users simultaneously, whereas others will switch only to the person who is speaking.

Industry accepted standards for facilitating videoconferencing interconnectivity. The standards are endorsed by the ITU (International Telecommunications Union). The standards are based upon the networking medium that is used to transmit audio, video and data associated with videoconferencing. The H.323 standard is a common video conferencing standard, implemented in Ethernet and Token-ring LANs, it is used in connection with the IP protocol transport. The H.320 standard relates to multimedia and videoconferencing over ISDN lines.

A session Initiation Protocol (SIP) is a signaling protocol, widely used for controlling multimedia communication sessions such as voice and video calls over Internet Protocol (IP). Other feasible application examples include video conferencing, streaming multimedia distribution, instant messaging, presence information and online games. The SIP protocol can be used for creating, modifying and terminating two-party (unicast) or multiparty (multicast) sessions consisting of one or several media streams. The modification can involve changing addresses or ports, inviting more participants, adding or deleting media streams, etc.

The SIP protocol is a TCP/IP-based application layer protocol. SIP is designed to be independent of the underlying transport layer; it can run on Transmission Control Protocol (TCP), User Datagram Protocol (UDP), or Stream Control Transmission Protocol (SCTP). It is a text-based protocol, incorporating many elements of the Hypertext Transfer Protocol (HTTP) and the Simple Mail Transfer Protocol (SMTP), allowing for direct inspection by administrators.

The 3G-324M is the 3rd generation partnership project (3GPP) umbrella protocol for video telephony in 3G mobile networks. 3G-324M is a solution for conversational multimedia based services that packet-based wireless networks cannot deliver because of inherent overhead, bit error rate (BER) sensitivity, and variant routing delays. 3G-324M operating over a circuit switched channel between two communication peers guarantees the fixed-delay quality of service for multimedia communications. Combining Circuit switched 3G-324M services with packet-based Session Initiation Protocol (SIP) services such as presence can leverage the strength of both networks to enable new types of differentiated and innovative mobile 3G services.

### BRIEF DESCRIPTION OF THE DRAWINGS

The invention may be understood upon reading of the following detailed description of non-limiting exemplary embodiments thereof, with reference to the following drawings, in which:

FIG. 1 is a general layout of the components of a network according to the present invention;

FIG. 2 is a block diagram showing the interactions between the components of a system of the present invention;

FIG. 3A is a block diagram describing the components of a service provider premises in connection with external network;

FIG. 3B is a block diagram describing the components of a service provider premises in connection with external network, with the agent connected through the external network;

FIG. 4 is a flow diagram showing the sequence of events that leads to a contact between a customer and a agent according to an embodiment of the invention; and

FIG. 5 is a flow diagram showing the sequence of events that leads to a control over the agent as consequence of issuance of request by the customer.

FIG. 6 is a flow diagram showing the sequence of events for controlling a flow of information from agent to a customer through a one-to-many proxy server connected to a LAN compliant with the H.323 or SIP standard;

The following detailed description of the invention refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

### DETAILED DESCRIPTION OF EMBODIMENTS OF THE INVENTION

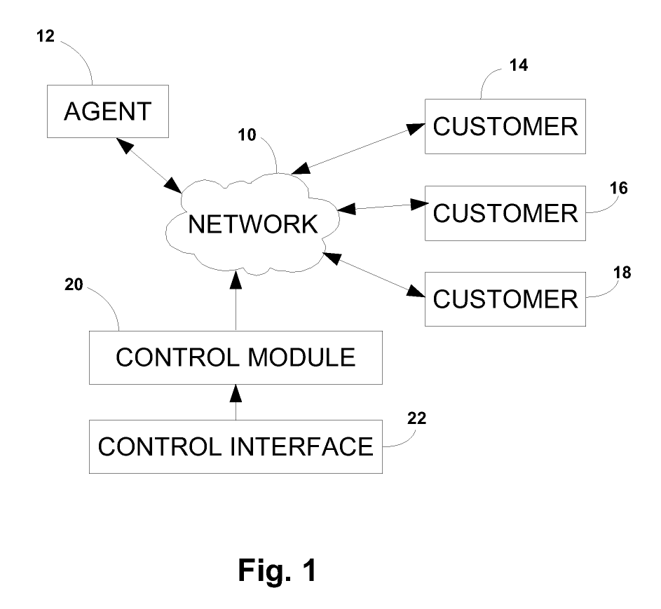

In the framework within which the present invention is implemented, several components are employed, as described schematically in FIG. 1 to which reference is now made. To a network 10 are connected several components. Agent 12 is the party that supplies the information, to customers 14, 16 and 18. Control module 20 interprets commands coming from control interface 22, to affect transmission of information from agent 12 to the customers.

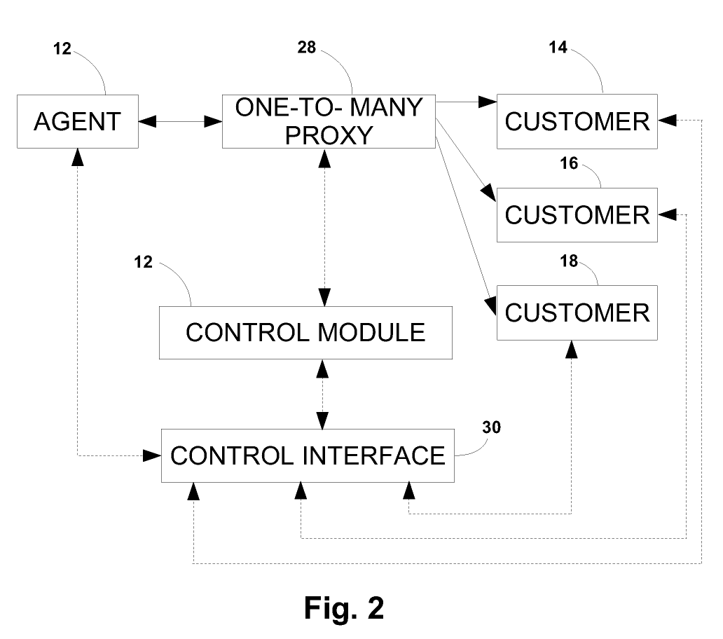

In FIG. 2, to which reference is now made, are described the information routes and the control channels of the system according to a preferred embodiment of the invention. Agent 12 transfers information to a one-to-many proxy server 28, thereafter referred to as OTMPS, which distributes the information to customers 14, 16, and 18. Control channels are indicated in dashed arrows, whereas solid arrows represent information flow. Agent 12 sends instructions to a control interface 30 and receives instructions from same. Control interface 30 sends control instructions to control module 32, and OTMPS receives control instructions from control module 32. Customers 14, 16 and 18 send control instructions to the control interface 30. In another embodiment, the agent 12 does not have a direct connection to control interface 30, and its interface with the system of the invention is effected exclusively through the OTMPS 28.

In some embodiments of the present invention control interface 30 includes the following operations; when a customer wishes to join an ongoing agent-to-customer video, audio and data transfer session, a connection is set up independently between a customer (e.g. customer 14) and agent 12 through control interface 30. The connection set up with customer 14 is established according to either H.323 or SIP standard. In some cases where customer's connection set up is established according to H.320 or 3G-324M, a suitable gateway is used to communicate with H.323 or SIP standard. Control interface 30 further matches the connection parameters to be the same as an ongoing session connection of agent 12 with other customers for example customer 18. If an ongoing session is established for example with agent 12 and customer 18 over a video resolution of 352×288 pixels then the new session setup of agent 12 with customer 14 will include the same parameters of the ongoing session in order to avoid a complex video processing which would be required if the parameters do not match.

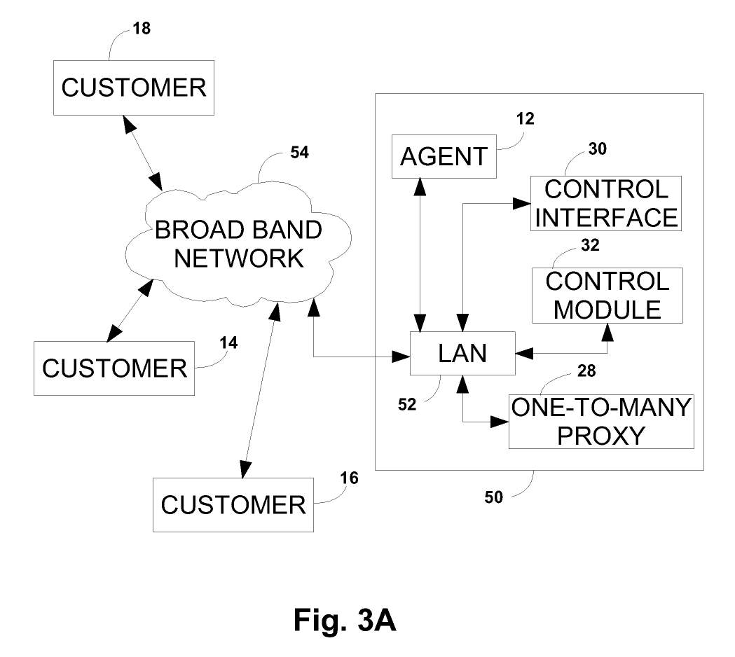

Reference is now made to FIG. 3A, which shows the architectural features of a system of a preferred embodiment of the invention. In the premises 50 of the service provider, an agent 12 is connected to a LAN 52. To the outside, the LAN 52 is connected to a broad band network 54, to which customers 14, 16, and 18 are also connected. In the service provider's premises 50, control interface 30 is connected to the LAN 52, control module 32 is connected to the LAN 52 and OPTMS 28 is connected to the LAN 52 as well. FIG. 3B to which reference is now made shows a slightly different embodiment of the invention in which the agent 12 does not necessarily reside within the service provider premises. In this case, the connection of agent 12 with the LAN 52 is mediated through the fast internet network 54.

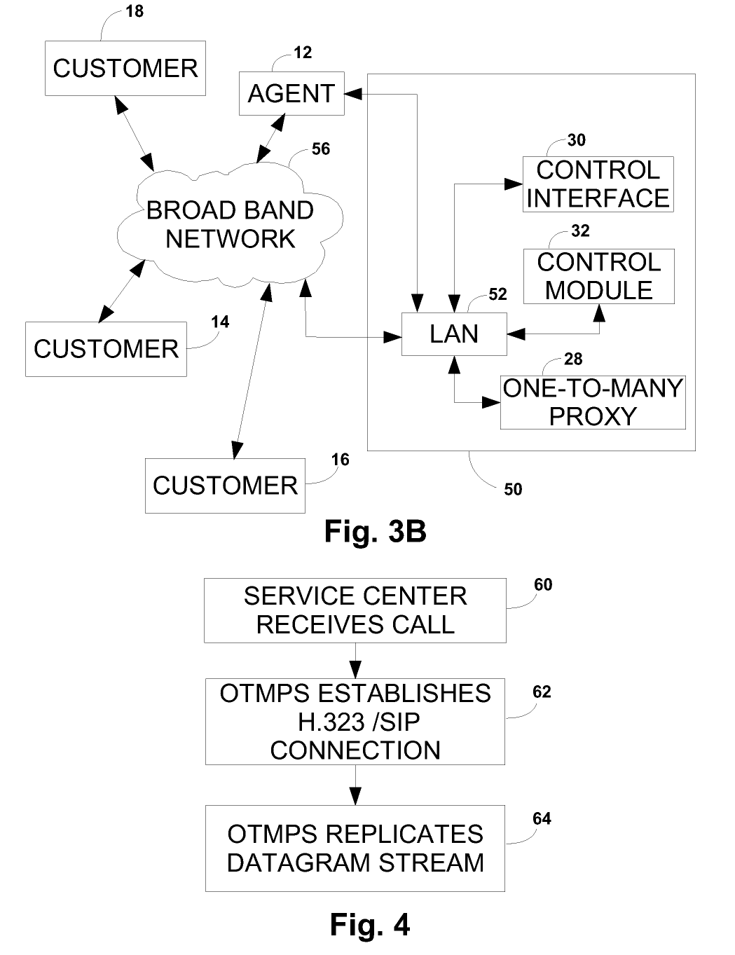

To explain the functionality of the present invention, reference is now made to FIG. 4, which describes the sequence of events taking place in a videoconferencing session performed in accordance with the present invention. A customer wishes to join an ongoing video, audio and data transfer session and calls service provider center in step 60. In step 62, the OTMPS establishes either H.323 or SIP connection with the calling customer. In some cases where the calling customer connection is established according to H.320 or 3G-324M, a suitable gateway is used to communicate with the H.323 or SIP standard connection.

As a consequence, in step 64, the control module instructs the OTMPS to produce another copy of the datagram stream representing the transmitted information between the customers and the agent.

When a customer wishes to join an ongoing agent-to-customer video, audio and data transfer session, his call, made through a broad band network or through an ISDN network to the service provider, must be received there. If an ISDN has been used for access according to the present invention, a gateway has to be employed using as an interface between the two networks (ISDN and LAN). At this point in time, the new customer is passively connected to the customer and obtains video, audio and data like the other customers, having been connected before.

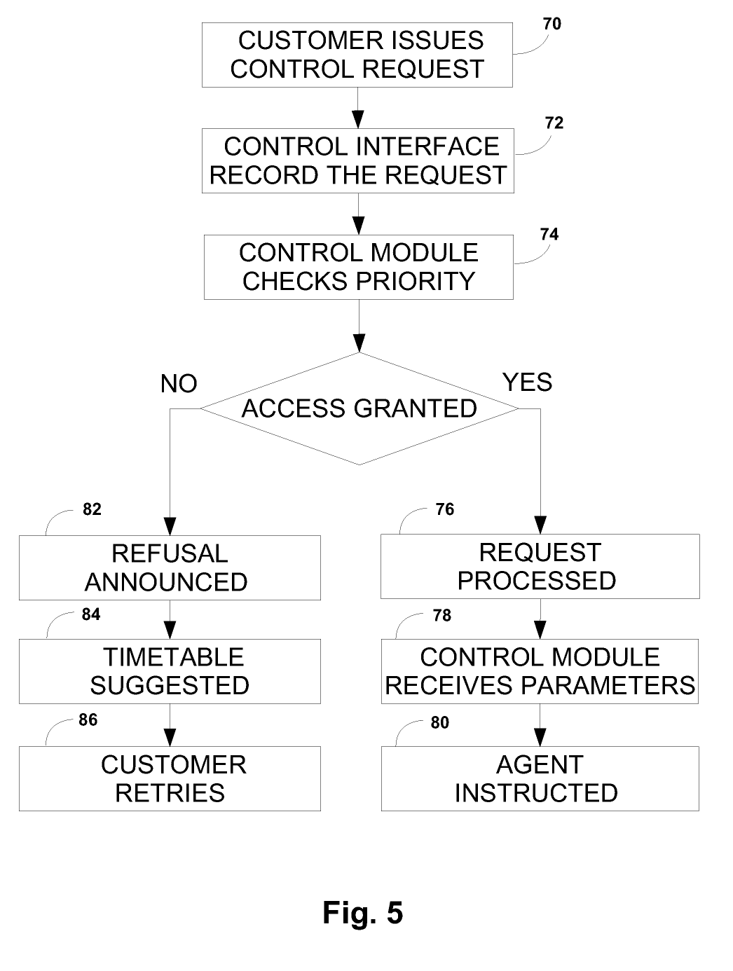

In accordance with a preferred embodiment of the present invention, whenever a connected customer wishes to instruct the agent to change the course of an ongoing session, such as provide a new source of information conveyed to the customers through the LAN, he then issues a control request. A suitable interface for such a request is a PC for a internet connection, or a video telephone for an ISDN connection or a mobile phone for example compliant with 3G-324M standard. FIG. 5, to which reference is now made, describes one approach for implementing a client takeover of an ongoing session. At step 70 the customer issues the request for control and at step 72 the control interface records the request. At step 74 the control module checks the priority parameters available for the registered customer, and in step 75 control access is granted depending upon the calling customer's priority parameters, a number of existing customers' parameters and on network parameters. In step 76 the request is processed, and in step 78 the control interface is given parameters for changing the ongoing agent output. In step 80, the agent is provided with a set of parameters as to the changes which are to be made effective. If access is not granted to the customer in step 75, refusal is announced in step 82, through customer's audio or video interface, and suggesting a timetable for interaction, based upon an updated timetable, at step 84. At step 86 the customers retries to control the interaction with the agent.

In some embodiments of the present invention when a customer wishes to join an ongoing agent-to-customer video, audio and data transfer session, a connection is set up independently between a customer (e.g. customer 14) and agent 12 through control interface 30. Customer 14 further requests a video update from agent 12. This update is required for example for the following reason: A video transmission including a key frame, followed only by the “delta” or difference, until the next key frame. In video compression, a key frame, also known as an intra frame, is a frame in which a complete image is stored in the data stream. In video compression, only changes that occur from one frame to the next are stored in the data stream, in order to greatly reduce the amount of information that must be stored. This technique capitalizes on the fact that most video sources have only small changes in the image from one frame to the next. For example, lets assume that customer 14 connects at a point in time to a video stream in an ongoing session between agent 12 and customer 16 which not include a key frame, the stream will be presented with only changes that occur from one frame to the next sent by the agent, and the video picture will be garbled because in order to view a video customer 16 need first to receive a key frame, and then the changes that occur from one frame to the next. To over come this problem control interface 30 forces agent 12 to send an update to new customer 16 in a form of complete key frame.

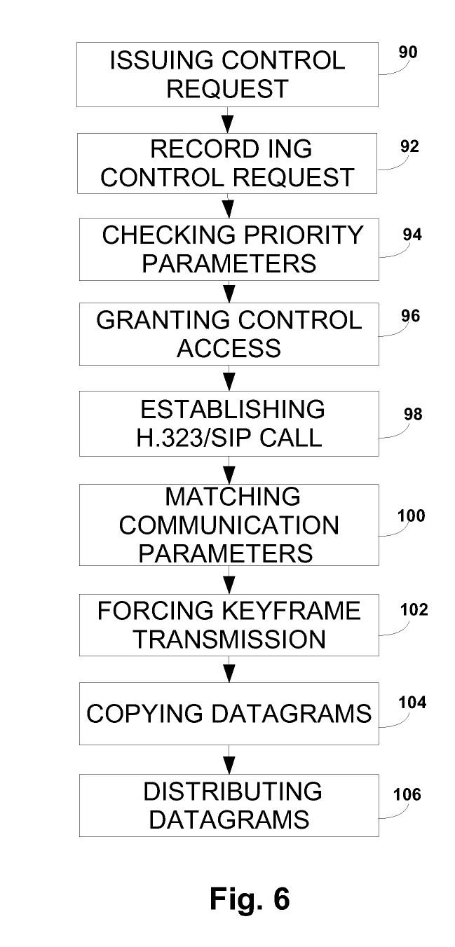

Referring now to FIG. 6 there is shown a flow diagram showing a sequence of events for controlling a flow of information from agent to a customer through a one-to-many proxy server connected to a LAN compliant with video conferencing standard in accordance with some embodiments of the present invention.

At step 90 a control request is issued for example by customer 14 to control interface 30 connected to LAN 52. The control request is recorded at step 92 by control module 32 which is also connected to LAN 52. Priority parameters of customer 14 are checked at step 94 by control module 32. At step 96 the control request issued by customer 14 is granted subject to permission by control module 32. A call for example according to H.323/SIP standard is established at step 98 with customer 14 as an independent connection (as opposed to multicasting). At step 100 communication parameters of customer 14 is forced to match with agent 12 ongoing session parameters, in order to make sure that replicated datagrams are valid. At step 102 a transmission of a key frame is forced to requested from agent 12. Datagrams are copied by one-to-many proxy server (OTMPS) at step 104 and a stream of datagrams flowing through said OTMPS are distributed at step 106 to at least one customer for example form plurality of customers, 14,16 and 18.

In some embodiment of the present invention the videoconferencing standard for controlling a flow of information from agent to a customer through OTMPS 28 connected to LAN 52 is either the H.320 or H.324M standard, for connecting either ISDN or 3G communications carrier through a gateway to LAN 52 respectively.

In some other embodiments of the present invention an ongoing session between agent 12 and one or more customers (e.g. customers 14, 16 and 18) is recorded for example by implementing the following procedure. One-to-many proxy server (OTMPS) 28 copies the datagrams of the ongoing session in the same method as described above for connecting a new customer who wishes to join an ongoing session in which information is transferred from the agent to the customer through a one-to-many proxy server, to facilitate transmission of information such as video, audio and data, or any combination thereof, to the new customer. The copied datagrams are stored in a file containing the video and audio streams of the session. The file can be retrieved and played back at a later stage.

It should be understood that the above description is merely exemplary and that there are various embodiments of the present invention that may be devised, mutatis mutandis, and that the features described in the above-described embodiments, and those not described herein, may be used separately or in any suitable combination; and the invention can be devised in accordance with embodiments not necessarily described above.

1. A system for connecting at least one customer to at least one agent to facilitate transmission of information, including at least one selected from the group consisting of video, audio and data, or any combination thereof, said connecting performed through a LAN complying with either the H.323 or SIP standard, the system comprising:
a control interface for connecting and mediating control instructions between said at least one customer and said at least one agent;
a control module for obtaining information from said control interface including the number of customers connected to said system and an address and priority parameter of each customer; and
a one-to-many proxy server for receiving instructions from said control module regarding the number of customers connected and their priority parameters, and producing a datagram stream representing the transmitted information between said customer and said agent;
wherein said control module instructs said one-to-many proxy server to produce another copy of a datagram stream, representing the transmitted information between said customer and said agent, for a customer joining an ongoing video, audio and data transfer session.

2. A system according to claim 1, wherein said interface comprises a control interface connected to said LAN for conveying and mediating control instructions between said at least one customer and said at least one agent.

3. A method for connecting a new customer to an ongoing session in which information is transferred from at least one agent to at least one customer through a one-to-many proxy server, to facilitate transmission of said information selected from a group consisting of video, audio and data, or any combination thereof, to said customer, said connecting being compliant with a videoconferencing standard, the method comprising:
receiving a call issued by said new customer in a control interface;
establishing either the H.323 or SIP call with said new customer;
notifying a control module by said control interface about the newly established customer call;
receiving instructions by said one-to-many proxy server from said control module regarding the number of customers connected to said session and the priority parameters of those customers;
producing a copy, by said one-to-many proxy server, of a datagram stream representing the transmitted information between at least one customer participating in the session and the at least one agent; and
transmitting the copy of the datagram stream to said new customer.

4. A method according to claim 3, and wherein said videoconferencing standard is either the H.323 or SIP standard.

5. A method according to claim 4, wherein said videoconferencing standard is either the H.320 or H.324M standard, for connecting either ISDN or 3G communications respectively carrier through a gateway to a LAN.

6. A method according to claim 3, wherein said produced copy of datagram stream is stored in a file containing the video and audio streams of said session and wherein said file is retrieved and played back at a later stage.

7. A method for controlling a flow of information from at least one agent to a customer, said information selected from a group consisting of video, audio and data or any combination thereof, said information flowing from said agent through a one-to-many proxy server connected to a LAN compliant with the videoconferencing standard, said method comprising the steps of:
issuing a control request to a control interface connected to said LAN;
recording said control request by a control module connected to said LAN;
checking the priority parameters of said customer by said control module;
granting control access to said customer subject to permission by said control module;
establishing an independent call connection either the H.323 or SIP standard with said customer;
establishing communication parameters with said customer to be the same parameters as in an ongoing agent-to-customer video, audio and data transfer session between said agent and at least one other customer.
requesting transmitting a key frame from said agent to said customer, and
copying by said one-to-many server a datagram stream flowing through said server to distribute it to at least one customer.

8. A method according to claim 7, and wherein said videoconferencing standard is either the H.323 or SIP standard.

9. A method according to claim 7, wherein said videoconferencing standard is either the H.320 or H.324M standard, for connecting ISDN or 3G communications respectively carrier through a gateway to a LAN.
